(19) United States
(12) Patent Application Publication
(10) Pub. No.: US 2005/0086472 A1
(43) Pub. Date: Apr. 21, 2005

(54) Methods of generating a verifiable audit record and performing an audit

(76) Inventor: Jon M. Peha, Pittsburgh, PA (US)

Correspondence Address: WILMER CUTLER PICKERING HALE AND DORR LLP, 60 STATE STREET, BOSTON, MA, 02109, US

(21) Appl. No.: 10/876,368

(22) Filed: Jun. 23, 2004

Related U.S. Application Data
(63) Continuation of application No. 10/161,083, filed on May 31, 2002, now abandoned.
Application No. 10/161,083 is a continuation of application No. 09/138,175, filed on Aug. 21, 1998, now abandoned.

(51) Int. Cl. H04L 9/00

(52) U.S. Cl. 713/168

(57) ABSTRACT

A method for associating data with documents that aid in the subsequent auditing of those documents. The invention in one embodiment further provides methods for auditing the documents. The associated data includes information for verifying the document's authorship, as well as for verifying that the document has not been altered. The associated data may further include information for verifying that the document's existence at a certain time. By associating verifiable authorship data, the invention provides methods for retrieval of all of a specific author's documents from a collection of documents.

### FIELD OF THE INVENTION

This invention relates to a method and apparatus for verifying transactions and more specifically for verifying electronic transactions.

### BACKGROUND OF THE INVENTION

The shift from paper-based to electronic records has raised new challenges in ensuring the integrity of documents. Whereas alteration of a physical, paper document is easily perceivable, the alteration of an electronic file can be done undetectably. As commerce has migrated from written form to electronic form, electronic documents have increasingly become the sole representation of transactions.

For paper-based, written records of transactions, the methods of ensuring an individual record's integrity are known in the art. These methods include handwritten signatures and notarization. An auditor examining a collection of physical records that have been signed and notarized may have a high degree of confidence that their contents are genuine. Furthermore, the auditor can readily perceive any tampering of these records.

Similarly, technologies such as public key cryptography and digital signatures have been employed to ensure the integrity of electronic documents. These technologies further may be employed to verifiably establish authorship of a document.

Although current technology exists to verify the contents and authorship of individual documents, the art currently lacks a systematic method for creating a verifiable audit trail for a collection of documents which allows the composition of the collection, as well as the contents and authorship of individual documents within the collection, to be verified. Currently lacking as well is the ability to retrieve data from a collection based on that data's verifiable authorship.

### SUMMARY OF THE INVENTION

The invention provides an apparatus and methods for associating data with electronic documents for the purpose of auditing those documents. In one embodiment the invention relates to a method for generating a Verifiable Audit Record including the steps of: providing an Auditable Document; associating Author Verification Information with the Auditable Document; and combining the Author Verification Information and indicia of the Auditable Document into a Verifiable Audit Record. In another embodiment, the indicia of the Auditable Document may include a Message Digest which is created by performing a one-way hash on the Auditable Document. In yet a further embodiment, a Timestamp is appended to the Verifiable Audit Record. In another embodiment, the Author Verification Information is generated using biometric information associated with the Author, such as a fingerprint or retina scan. In another embodiment, the Author Verification Information is generated using public key cryptography.

In another embodiment the invention relates to a method for performing an audit including the steps of providing an Auditable Document; providing a Verifiable Audit Record of the Auditable Document, and verifying that the Verifiable Audit Record is a correct representation of the Auditable Document. In one embodiment the Verifiable Audit Record includes Author Verification Information and indicia of the Auditable Document.

In another embodiment the invention relates to a method for performing an audit including the steps of registering an Author with a Verifier; providing an Auditable Document; submitting the Auditable Document to a Notary to provide verifiable indicia for the Auditable Document; submitting the Auditable Document with verifiable indicia to an Auditor; providing Author Verification Information from the Verifier; and applying the Author Verification Information to the Auditable Document by the Auditor. In one embodiment the Auditable Document includes a receipt which includes information encoded by a First Transactor and a Second Transactor. In another embodiment, the First and Second Transactors each have a key pair including a private and a public key, and each Transactor encodes information using their respective private key.

In another embodiment the invention relates to a method for generating a Verifiable Audit Record including the steps of an Author submitting an Auditable Document to a Notary and the Notary storing the Auditable Document, an identity of the Author and Author Verification Information and generating a Message Digest. The Message Digest in one embodiment includes the output of a one-way hash function, wherein the input to the one-way hash function includes the Auditable Document, the identity of the Author, and the Author Verification Information. The Notary then places the Message Digest so as to be observable by an Auditor.

In another embodiment the invention relates to a method for verifying that a Notary has not changed a Message Digest available to an Auditor, including the steps of: the Auditor accessing the Message Digest; the Auditor storing the Message Digest; the Auditor determining that a subsequent accessed Message Digest is substantially identical to the stored Message Digest.

In another embodiment the invention relates to a method for insuring data integrity including the steps of: providing by a Notary an Auditable Document, an identity of an Author, Author Verification Information and a Putative Message Digest; generating by an Auditor a Test Message Digest, and comparing by an Auditor the Putative Message Digest to the Test Message Digest. The Test Message Digest includes the output of a one-way hash function, wherein the input to the one-way hash function includes the Auditable Document, the identity of the Author, and the Author Verification Information.

In another embodiment the invention relates to a method for insuring data integrity including the steps of: providing a plurality of records, wherein the records include a plurality of Timestamps; verifying that the plurality of Timestamps are non-decreasing; and verifying that the plurality of Timestamps are all previous to the present time.

In another embodiment the invention relates to a method for collecting all documents from an Author including the steps of: a Notary examining its Verifiable Audit Records for Author Verification Information; and storing the Verifiable Audit Record when the Author Verification Information indicates authorship by the Author.

In another embodiment the invention relates to a method for verifying a Document including the steps of: providing a Notary's Public Record of the Document which includes the output of a function whose input includes information associated with the Document; generating a Test Record which includes the output of a function whose input includes information associated with the Document; and verifying that the Notary's Public Record and the Test Record are identical.

### BRIEF DESCRIPTION OF THE DRAWINGS

The foregoing and other objects, features and advantages of the present invention, as well as the invention itself, will be more fully understood from the following description of preferred embodiments, when read together with the accompanying drawings, in which:

FIG. 1 is a flow diagram depicting the creation of an Audit Record, its submission to a Notary, and its subsequent auditing.

FIG. 2 is a flow diagram depicting the process of creating an Audit Record which does not include the contents of the original Auditable Document.

FIG. 3 is a flow diagram depicting the process of retrieving and verifying an Audit Record.

FIG. 4 is a flow diagram depicting the process of creating an Audit Record of a transaction between a Buyer and a Seller.

FIG. 5 is a flow diagram depicting the process of retrieving and verifying an Audit Record of a transaction between a Buyer and a Seller.

FIG. 6 is a flow diagram depicting the process of creating an Audit Record.

FIG. 7 is a flow diagram depicting the process of retrieving and verifying an Audit Record which does not include the contents of the original Auditable Document.

### DETAILED DESCRIPTION OF PREFERRED EMBODIMENTS

For the purposes of this invention, a document which may ultimately be audited is referred to herein as the Auditable Document. In one embodiment, the contents of an Auditable Document is a record of a transaction, such as a sale, between two or more parties. For the purposes of this invention, any of the parties involved in a transaction may be considered an Author of the Auditable Document. Because the data associated with an Auditable Document include information regarding its authorship, the data associated with an auditable document are collectively referred to as Author Verification Information.

Author Verification Information in one embodiment includes information encrypted by an Author, such as indicia of the Auditable Document. In one embodiment, the encryption is performed with public key cryptography, and the Author Verification Information further includes retrieval information for the Author's public key. In one embodiment, Author Verification Information also includes biometric information associated with an Author, such as a fingerprint, or a handwriting sample.

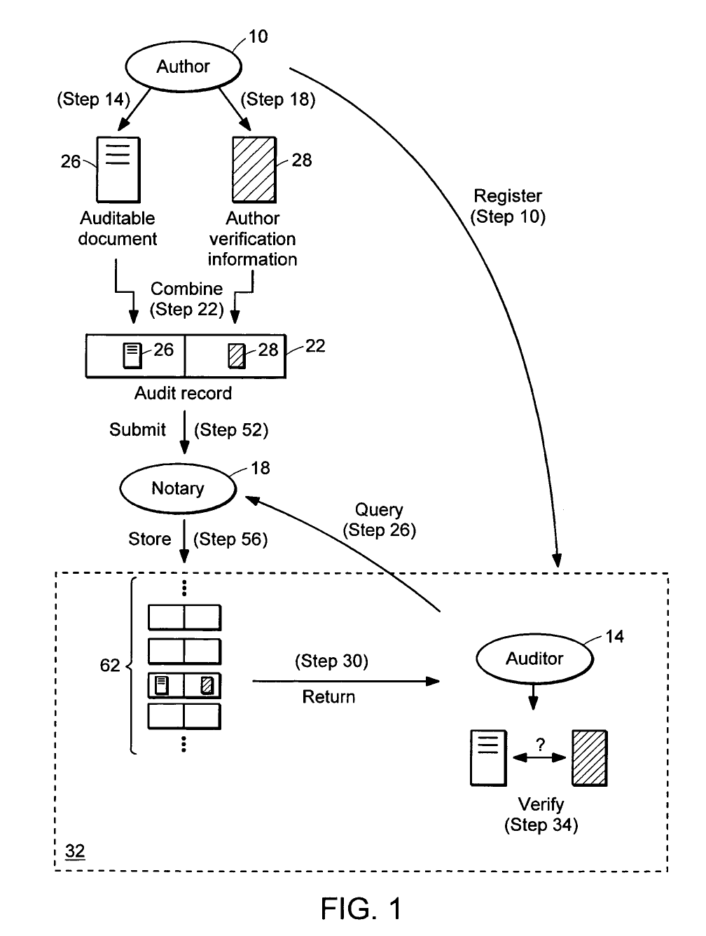

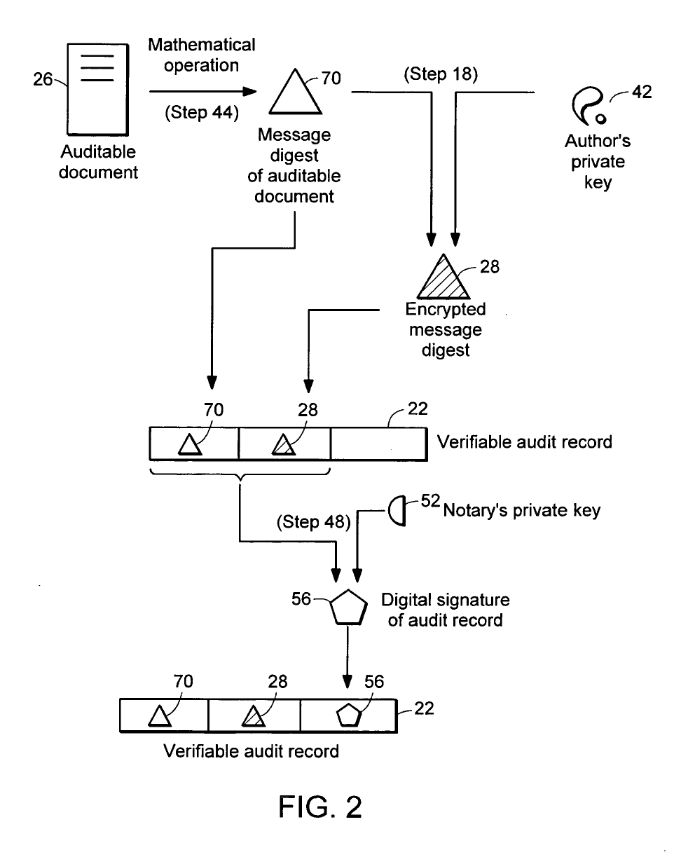

The invention provides methods for combining indicia of an Auditable Document and its associated Author Verification Information. For the purposes of this invention, and as illustrated in FIG. 1, this combination of document data and author data is referred to as a Verifiable Audit Record 22. Referring also to FIG. 2, indicia of the Auditable Document 26 may include an encoded form of the document termed a Message Digest 70. One method of creating (step 44) a Message Digest 70 is to use the output of a mathematical manipulation performed on the contents of the Auditable Document 26. One mathematical manipulation that may be used is a one-way hash function. Another indicia of the Auditable Document 26 may include the Auditable Document 26 in encrypted form. Yet another indicia of the Auditable Document 26 may simply be the Auditable Document 26 itself. At a minimum, a Verifiable Audit Record 22 must contain indicia of an Auditable Document 26 and its associated Author Verification Information 28, but it may include other information. For example, the Verifiable Audit Record 22 may also include a Timestamp and associated Timestamp verification information, as well as information that helps to verify that the Author Verification Information 28 has not been tampered with. Analogous to the indicia of an Auditable Document 26, the indicia of a Verifiable Audit Record 22 may include the individual Verifiable Audit Record 22 itself, a Message Digest of the individual Verifiable Audit Record 22, or an encrypted individual Verifiable Audit Record 22. Furthermore the indicia may be of a collection of Verifiable Audit Records 22.

In one method, an Auditor 14 retrieves a Verifiable Audit Record 22 from a Notary 18 and compares it to its putatively associated Auditable Document 26 in order to verify that the Verifiable Audit Record 22 is an accurate representation of the Auditable Document 26. The Auditor may further verify that the Verifiable Audit Record 22 has not been tampered with subsequent to its submission to the Notary 18. The audit may be performed on a collection of Verifiable Audit Records 22. Because a Verifiable Audit Record 22 contains Author Verification Information 28, an Auditor 14 is able to retrieve all of the Verifiable Audit Records 22 that were submitted by a particular Author 10.

Referring again to FIG. 1, which provides an overview of the invention, to create an audit record an Author 10 first registers (step 10) with an Auditor 14, informing the Auditor 14 of which Notary 18 the Author 10 will use to store his Audit Records 22. Then, whenever the Author 10 creates (step 14) an Auditable Document 26, he also creates (step 18) associated Author Verification Information 28. The Author 10 then combines (step 22) the Auditable Document 26 and Author Verification Information 28 into an Audit Record 22, and submits the Audit Record 22 to a Notary 18.

The Auditor 14 performs an audit on the Author 10 by querying (step 26) the Notary 18 for all Audit Records 22 submitted by the Author 10. The Notary 18 provides (step 30) the Auditor 14 all of the Audit Records 22 submitted by the Author 10. The Auditor 14 verifies each Audit Record 22 by examining its Author Verification Information 28 and using it to ascertain whether or not the Auditable Document 26 was created by the Author 10, and whether or not the Auditable Document 26 has been modified.

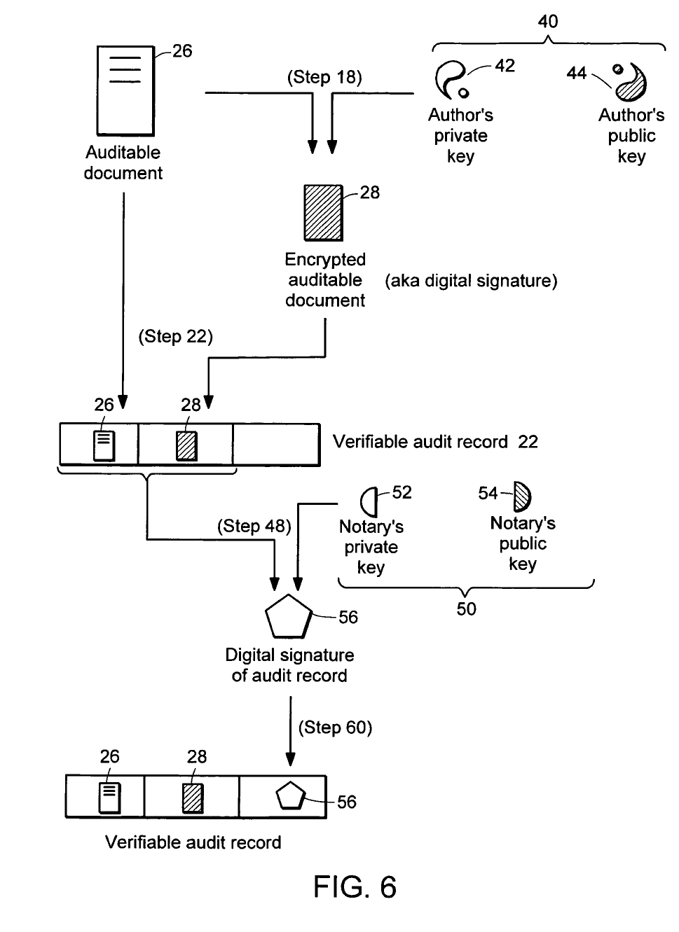

Public key cryptography may be used to provide verification information for an Author 10 and for an Audit Record 22 which may be used when an audit is performed. As shown in FIG. 6, in this embodiment an Author 10 has an Auditable Document 26 and a key pair 40 which typically consists of a private key 42 and a public key 44. The Author 10 generates (step 18) Author Verification Information 28 by encrypting the Auditable Document 26 with his private key 42. The Author 10 then combines (step 22) the Auditable Document 26 and Author Verification Information 28 into an Audit Record 22, which he then submits (step 56) to a Notary 18. The Notary 18, who has his own key pair 50, then uses his private key 52 to encrypt (step 48) a copy of the Audit Record 22. This encrypted copy 56 is then appended (step 60) to the Audit Record 22.

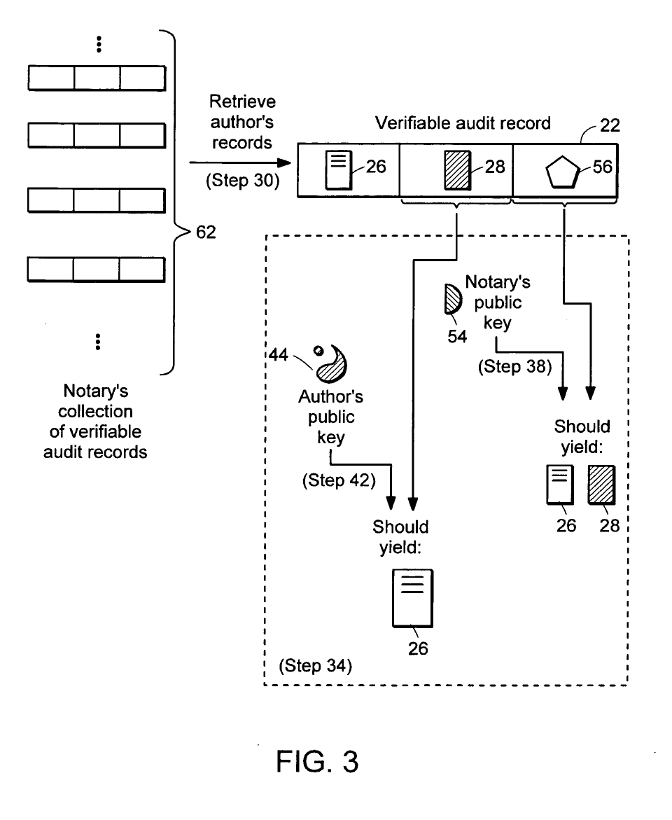

FIG. 3 depicts an embodiment of the retrieval (step 30) and verification (steps generally 34) of FIG. 1 that an Auditor 14 performs when performing an audit. In this example, an Auditor 14 retrieves (step 30) all of an Author's 10 Verifiable Audit Records 22 from a Notary's collection 62, and verifies each one in turn. For each Audit Record 22, the Auditor 14 uses the Notary's public key 54 to decrypt (step 38) the encrypted copy 56 of the Verifiable Audit Record 22. If the decrypted copy matches the Verifiable Audit Record 22, the Auditor 14 is assured that the contents of the Verifiable Audit Record 22 have not been modified since their submission to the Notary 18.

The Auditor 14 then uses the Author's public key 44 to decrypt (step 42) the encrypted Author Verification Information 28. If the decrypted Author Verification Information 28 matches the Auditable Document 26, the Auditor 14 is assured that the contents of the Auditable Document 26 have not been modified since being signed, and that the putative Author 10 did, in fact, sign the Auditable Document 26.

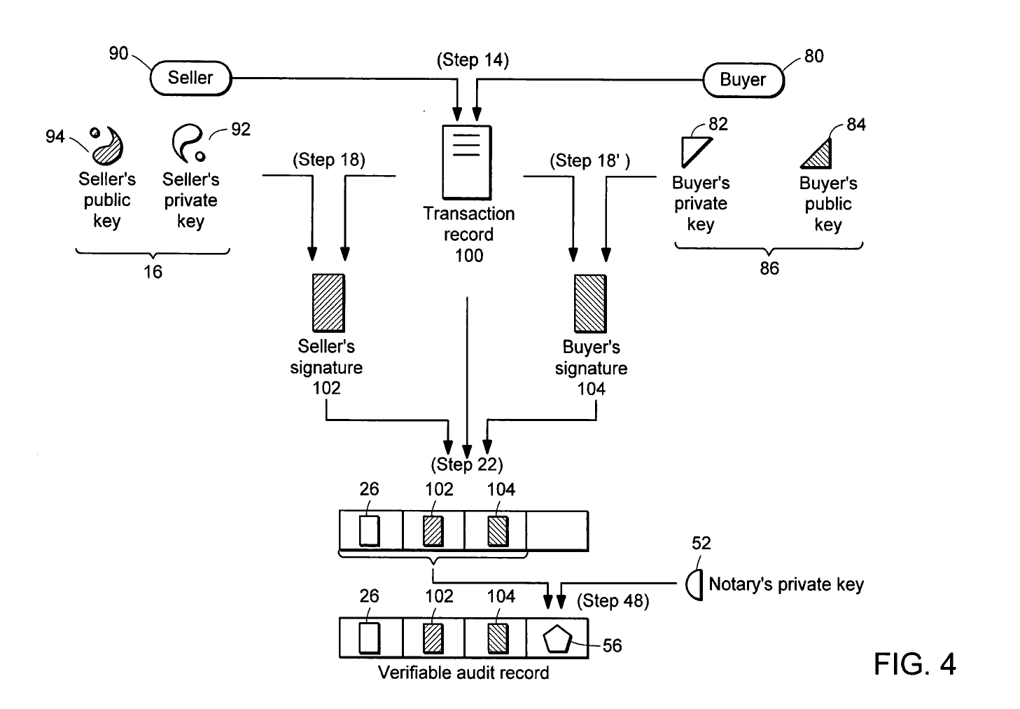

In one embodiment, the Auditable Document 26 is the record of a transaction between two Authors, termed herein a Buyer 80 and a Seller 90. As depicted in FIG. 4, the Buyer and Seller first make (step 14) a record 100 of their transaction. The Buyer 80 and Seller 90, who each have their own key pair, 86 and 96 respectively, each create (steps 18 and 18′) their respective Author Verification Information 102 and 104 by encrypting a copy of the transaction record 100 with their respective private keys 82 and 92. These encrypted copies 102 and 104 are then combined with the original record 100 to form a Verifiable Audit Record 22 and submitted to a Notary 18. The Notary 18 then uses his private key 52 to encrypt a copy of the submitted Verifiable Audit Record 22 and appends this encrypted copy 56 to the Verifiable Audit Record 22.

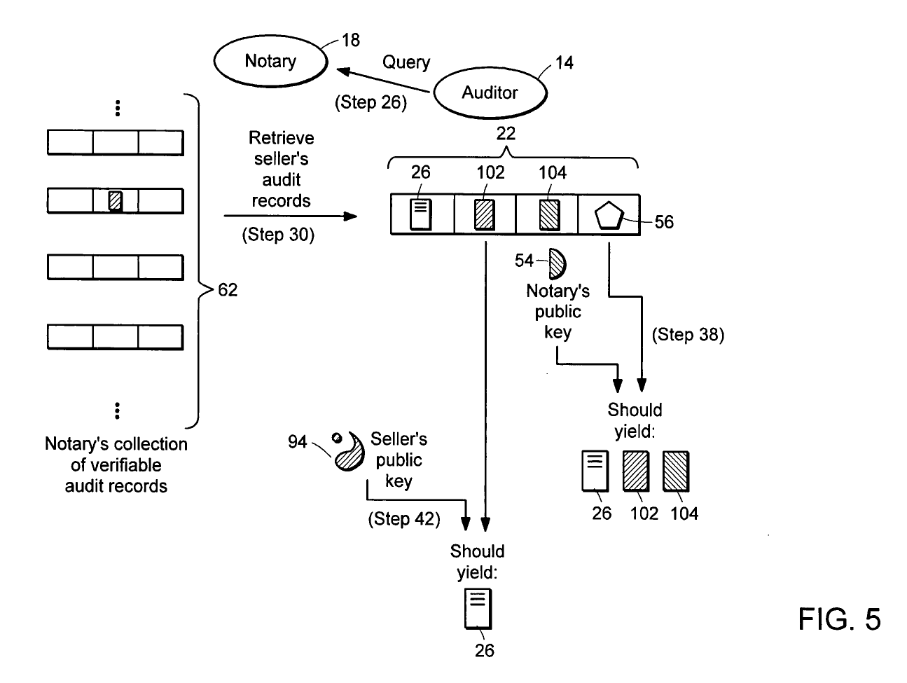

FIG. 5 depicts the steps an Auditor 14 performs when performing an audit on the Seller 90. Prior to the transaction, the Seller 90 has registered with an Auditor 14, informing the Auditor 14 which Notary 18 the Seller 90 intends to employ to record his transactions. When performing an audit, the Auditor 14 queries (step 26) the Notary 18 for all of the Verifiable Audit Records 22 the Seller 90 has submitted. In response, the Seller's Notary 18 provides (step 30) the Auditor 14 all of the Verifiable Audit Records 22 the Seller 90 has submitted.

Next, the Auditor 14 verifies (step 34) that each Verifiable Audit Record 22 has not been modified since submission to the Notary 18 (step 38), and that the Seller's Author Verification Information 102 is genuine (step 42). For each Verifiable Audit Record 22, the Auditor 14 uses the Notary's public key 54 to decrypt (step 38) the encrypted copy 56 of the Audit Record 22. If the decrypted copy matches the Verifiable Audit Record 22, the Auditor 14 is assured that the contents of the Verifiable Audit Record 22 have not been modified since their submission to the Notary 18. The Auditor 14 then uses the Seller's public key 94 to decrypt (step 42) the encrypted Author Verification Information 102. If the decrypted Author Verification Information 102 matches the plaintext copy of the Auditable Document 26, the Auditor 14 is assured that the contents of the Auditable Document 26 have not been modified since being signed, and that the Seller 90 did, in fact, sign the Auditable Document 26.

In the previous embodiments, the contents of the Auditable Document 26 have been made available to the Notary 18. This situation may not be acceptable to an Author 10 when the Auditable Document 26 contains sensitive information. In one embodiment, illustrated in FIG. 2, the Verifiable Audit Record 22 does not reveal any information about the contents of the Auditable Document 26. In this embodiment, the Author 10 creates a Message Digest 70 of the Auditable Document 26 by performing a mathematical manipulation on it termed a one-way hash, so called because a Message Digest 70 created in this manner cannot be used to deduce the contents of the original Auditable Document 26. If the Auditable Document 26 is modified, a one-way hash performed on the modified document will produce a different Message Digest 70. In addition to preserving the secrecy of the original document, a Message Digest 70 has the additional benefit of being smaller.

Once the Author 10 has made a Message Digest 70, he then creates Author Verification Information 28 by encrypting a copy of the Message Digest 70 with his private key. The Author 10 then combines the Message Digest 70 and Author Verification Information 28 into an Audit Record 22, which he then submits to a Notary 18. The Notary 18 then uses his private key 52 to encrypt a copy of the submitted information and appends this encrypted copy 56 to the submitted information, thus forming a Verifiable Audit Record 22.

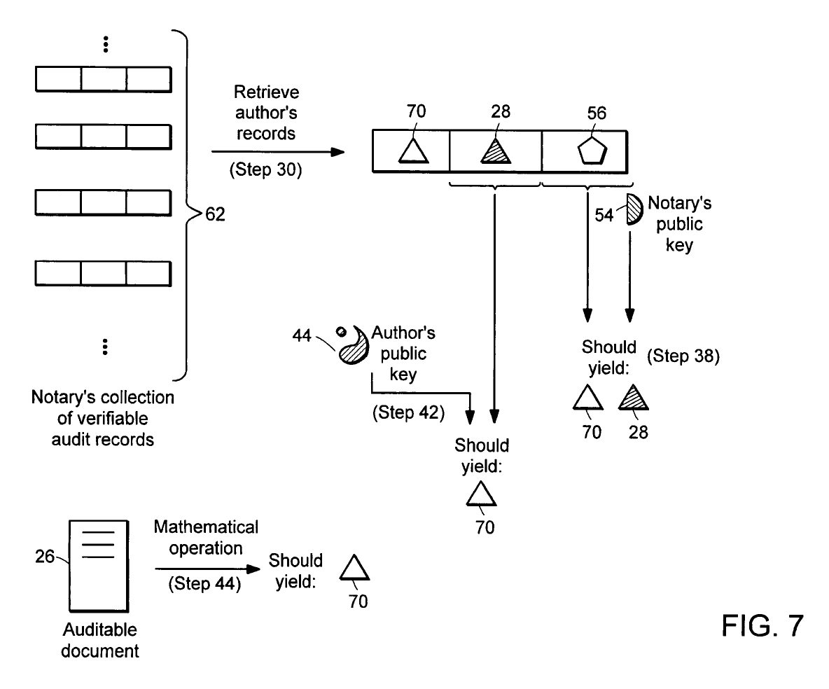

FIG. 7 depicts the steps involved in auditing this sort of Verifiable Audit Record 22. As in the previous examples, the Auditor 14 retrieves (step 30) all of an Author 10's Verifiable Audit Records 22 from a Notary 18 and verifies each one in turn. As in the previous examples the Auditor 14 uses the Notary's public key 54 to verify that the Verifiable Audit Record 22 has not been modified since submission. The Auditor 14 then uses the Author's public key 44 to verify that the Message Digest 70 belongs to the Author 10 and has not been tampered with. Finally, the Auditor 14 obtains a copy of the original Auditable Document 26 from the Author 10 and creates a Message Digest 74 of it. If the newly-created Message Digest 74 is identical to the Message Digest 70 retrieved from the Notary 18, the Auditor 14 is assured that the Auditable Document 26 belongs to the author and has not been tampered with.

The Verifiable Audit Record 22 will ultimately be submitted to and stored with a Notary 18. In one embodiment, the Verifiable Audit Record 22 may further include information regarding its time of submission to the Notary 18. For the purposes of this invention, this information is referred to as a Timestamp. The contents of the Timestamp are generated according to the time of submission of the Verifiable Audit Record 22 to the Notary 18. In order to verifiably associate the Timestamp with the Verifiable Audit Record 22, the contents of the Timestamp may further be generated according to the contents of the Verifiable Audit Record 22 being submitted. The contents of the Timestamp may yet further be generated according to externally verifiable and unpredictable data such as the official current temperature and humidity at a specific location or from a specific source at the time of submission. The Timestamp may include other information to validate its authenticity.

The invention also provides methods for ensuring that the Timestamps belonging to a series of Verifiable Audit Records 22 are genuine. In one of these methods, the Verifiable Audit Records 22 are retrieved by an Auditor 14 in the putative order in which they were submitted. The Timestamp of each Verifiable Audit Record 22 is analyzed in order to verify that each Timestamp represents a time subsequent to the that of the Timestamp of the previously submitted record. In other words, the Timestamps are verified to be non-decreasing, i.e. every record A that was putatively submitted before any record B bears a Timestamp earlier than that on record B. In another method of this invention, a Timestamp is examined to determine that it does not represent a time subsequent to the present time. This method requires that the order of the records accurately reflects the order in which they were submitted. In other words, this method requires that the order of the records be trusted.

The invention further provides methods for ensuring that Verifiable Audit Records 22 have not been modified subsequent to their submission to a Notary 18 that do not require that the Notary 18 be trusted. In one such method, the Notary 18 maintains indicia of its Verifiable Audit Records 22 on public display. In a similar method, the indicia are not on public display, but are made constantly available to a specified party, such as an Auditor 14. In these methods, because the Verifiable Audit Records 22 are kept where they can be viewed and recorded by others, the Notary 18 cannot alter these records without risking subsequent detection.

In another method for ensuring that Verifiable Audit Records 22 have not been modified subsequent to their submission to a Notary 18, the Verifiable Audit Records 22 include Audit Record Verification Information 56. Such information may include a Notary's digital signature. Such information may also be based upon one or more previously submitted Verifiable Audit Records 22. In yet another method for ensuring that Verifiable Audit Records 22 have not been modified subsequent to their submission to a Notary 18, an Author 10 submits the same information to several different Notaries 18. If the Verifiable Audit Record 22 is subsequently modified by one of the Notaries 18, any discrepancy is detectable.

In one method, the Notary 18 may return a receipt upon submission of a Verifiable Audit Record 22. For the purposes of this invention, the receipt will be referred to as a Notary's Certificate. In one method, the Notary's Certificate includes Audit Record Verification Information 56.

### EXAMPLE

The following example is intended to illustrate an application of the invention in the context of an Internet content-provider. The example is for illustrative purposes only, and should not be seen as limiting to the scope of the invention.

In this example, a stock analyst sells reports over the Internet. Because these reports are timely and time-sensitive, the report is sold for $10,000 the first two days after the report is released, and $100 thereafter. With each report, agreements with operators of relevant databases throughout the country provide free access to subscribers of the report for the first 24 hours after their purchase. These databases are accessed over the Internet. The analyst has agreed to pay 50% of all revenues to the investors who helped launch the reporting business, and the investors want to verify they receive their 50% of the revenue.

Each customer has an account with a bank that assigns the customer a public and private key for encryption. The analyst knows nothing about the customer's identity, except the customer's account number at the bank, and the fact that the bank must have checked their credit. Privacy protection is essential to the analyst's customers. The bank also maintains a pair of encryption keys for the analyst. Given an account number for a bank customer, the bank will provide anyone with the associated public encryption key.

A customer wishes to purchase a report. The analyst creates a bill of sale, which identifies the report, the price, and the current date and time. A transaction record is then constructed consisting of the bill of sale, the bill of sale encoded with the analyst's private key, the bill of sale encoded with customer's private key, and the account number of each of them with the bank. The transaction record is enough to prove to the bank that the customer's account should be debited, and to prove that the customer should have access to the databases in the 24 hour period after the listed data and time—provided the transaction record is accurate.

Two days later, the analyst may prefer to make the date listed on the bill of sale later so he can under-report revenues to his investors. The customer would also like to change the date so she can prolong her access to those databases.

Assume for this example that the analyst has registered with four notaries, i.e. that the analyst has informed the investors that each of the transactions will be notarized by one of these four notaries. Once the transaction record is complete, the analyst passes it through a one-way hash, and sends the result to one of the four notaries. The analyst will also send this result encoded with the analyst's private key, and the analyst's account number at the bank. The notary will use the latter to retrieve analyst's public key and verify the analyst's identity. The notary will append the current time, the current official temperature at a predefined location, and the parameter (i) where this is the i'th submission to that notary, to the information provided by the analyst, producing a string R. The notary returns R to the analyst as a receipt, and the analyst gives the customer a copy as well. The notary also runs R through a one-way hash. The output of the one-way hash and the parameter (i) are stored on the notary's web page, which is observable by anyone. Thus, any subsequent alterations of this value might be noticed. The notary also stores the other information in the receipt, but not in public view. Thus, privacy is not compromised; no one can tell from looking at the web page who is submitting items to the notary, or what has been submitted.

When the customer wants access to one of those databases, the customer must give the database operator the customer's transaction record, and the receipt R received by the customer from the notary. The transaction record will demonstrate when the customer made the purchase. The database operator can verify that this transaction record is precisely what was submitted to the notary by running the transaction record through the same one way hash used by the analyst and comparing the result with what is stored in the receipt. The time in the bill of sale should also be fairly close to the one in the receipt. Furthermore, the database operator can make sure that the receipt has not been altered by running it through the one-way hash used by the notary, and comparing the result with the i'th value on the notary's web page.

The investors of the analyst can also verify that all revenues have been accounted for. The investors know the four notaries the analyst uses, and the four notaries can produce all of the analyst's transactions in a given period. If the analyst reports all revenues, each sale in the analyst's own records should correspond to a verifiable transaction with these notaries, and vice versa Each of the transactions is checked using the method described in the preceding paragraph. An external auditor such as a taxing agency observes the notary. Occasionally, the investors may request that the next time the auditor investigates a given notary, the auditor insures that the notary has responded completely to one of these inquiries, i.e. that every entry from the stock analyst within a given time period was reported. Since the notary never knows which response will be investigated, there is always deterrence for an incomplete response.

The auditor randomly records some of the data stored on the web page, checking later to see that this data has not been altered. The auditor also periodically examines the data that is not on public display (which includes author identification information) to insure that if you apply the appropriate one-way hash, it does yield the value that is on public display. The auditor can also check to insure that each new transaction has a time that is later than the previous transactions, i.e. those with smaller values of (i) and earlier than the time of the audit. In addition, the time and official temperature in each entry should correspond. Finally, auditors occasionally respond to queries from the investors. With these safeguards, even if the notary and all other parties conspire to alter records, there is significant risk of detection. That risk is further enhanced by having multiple independent auditors, only one of which need be competent and honest to deter fraud.

### Equivalents

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

1. A method for generating a Verifiable Audit Record comprising the steps of:
(a) providing an Auditable Document;
(b) associating Author Verification Information with said Auditable Document;
(c) combining said Author Verification Information and indicia of said Auditable Document into a Verifiable Audit Record.

2. The method of claim 1 wherein said indicia comprises a Message Digest.

3. The method of claim 2 wherein said Message Digest comprises the output of a one-way hash function.

4. The method of claim 3 wherein the input of said one-way hash function comprises said Auditable Document.

5. The method of claim 1 wherein said indicia comprises an encrypted Auditable Document.

6. The method of claim 1 further comprising the step of:
(d) appending a Timestamp to said Verifiable Audit Record.

7. The method of claim 6 wherein said Timestamp is generated by a Timestamp Generating Function, wherein the input to said Timestamp Generating Function comprises externally verifiable, unpredictable data.

8. The method of claim 6 wherein said Timestamp comprises Timestamp Validation Information.

9. The method of claim 6 further comprising the steps of:
(e) providing a plurality of Verifiable Audit Records, wherein said Verifiable Audit Records comprise a plurality of Timestamps;
(f) verifying that said plurality of Timestamps are non-decreasing; and
(g) verifying that said plurality of Timestamps are all previous to the present time.

10. The method of claim 9 further comprising the steps of:
(h) providing a first record at audit time t, said first record comprising a first Timestamp;
(i) verifying that said first Timestamp is previous to audit time t;
(j) providing a second record subsequent to time t, wherein said second record comprises a second Timestamp; and
(k) verifying that said second Timestamp is subsequent to audit time t.

11. The method of claim 1 further comprising the step of:
(d) submitting said Verifiable Audit Record to a Digital Notary.

12. The method of claim 11 wherein said Digital Notary maintains indicia of said Verifiable Audit Record such that said Verifiable Audit Record is accessible to an Auditor.

13. The method of claim 11 wherein said Digital Notary maintains indicia of said Verifiable Audit Record on public display.

14. The method of claim 1 further comprising the step of:
(d) associating Audit Record Verification Information with said Verifiable Audit Record.

15. The method of claim 14 wherein said Audit Record Verification Information comprises indicia of said Verifiable Audit Record.

16. The method of claim 14 wherein said Audit Record Verification Information comprises indicia of one or more previously submitted Verifiable Audit Records.

17. The method of claim 1 wherein said Author Verification Information comprises information known only to an Author and a Digital Notary.

18. The method of claim 1 wherein said Author Verification Information comprises biometric information associated with an Author.

19. The method of claim 1 wherein said Auditable Document comprises information related to a transaction between a First Transactor and a Second Transactor.

20. The method of claim 19 wherein said Author Verification Information comprises information encrypted by one of said First Transactor and said Second Transactor.

21. The method of claim 1 wherein said Author has a key pair, wherein said key pair comprises a public key and a private key, and wherein said Author Verification Information comprises indicia of information encrypted by said Author's private key.

22. The method of claim 21 wherein said Author Verification Information further comprises retrieval information for said Author's public key.

23. The method of claim 1 wherein said indicia of encrypted information comprises a Message Digest of said encrypted information.

24. The method of claim 23 wherein said Message Digest comprises the output of a one-way hash function, wherein the input of said one-way hash function comprises said encrypted information.

25. The method of claim 1 wherein said information encrypted by said Author comprises a Challenge Text.

26. The method of claim 25 wherein said said Challenge Text is provided by a Digital Notary.

27. A method for performing an audit comprising the steps of:
(a) providing an Auditable Document;
(b) providing a Verifiable Audit Record of said Auditable Document, wherein said Verifiable Audit Record comprises Author Verification Information and indicia of said Auditable Document; and
(c) verifying that said Verifiable Audit Record is a correct representation of said Auditable Document.

28. The method of claim 27 further comprising the step of retrieving said Verifiable Audit Record from a plurality of Digital Notaries.

29. The method of claim 28 further comprising the step of retrieving a plurality of Verifiable Audit Records from said plurality of Digital Notaries.

30. The method of claim 29 wherein said plurality of Verifiable Audit Records is selected based on the contents of said Author Verification Information.

31. The method of claim 27 wherein verification step (c) comprises the steps of:
(d) creating an Auditable Document Digest, wherein said Auditable Document Digest is the output of a mathematical manipulation on said Auditable Document;
(e) comparing said Auditable Document Digest to said Verifiable Audit Record.

32. A method for performing an audit comprising the steps of:
(a) registering an Author with a Verifier;
(b) providing an Auditable Document;
(c) submitting said Auditable Document to a Notary to provide verifiable indicia for said Auditable Document;
(d) submitting said Auditable Document with verifiable indicia to an Auditor;
(e) providing Author Verification Information from said Verifier;
(f) applying said Author Verification Information to said Auditable Document by said Auditor.

33. The method of claim 32 wherein said Verifier is a Certification Authority.

34. The method of claim 32 wherein said Auditable Document comprises a receipt, wherein said receipt comprises information encoded by a First Transactor and information encoded by a Second Transactor.

35. The method of claim 34 wherein said First Transactor has a key pair, consisting of a private key and a public key, and said Second Transactor has a key pair, consisting of a private key and a public key, wherein said information encoded by said First Transactor is encoded by said First Transactor's private key and information encoded by said Second Transactor is encoded by said Second Transactor's private key.

36. The method of claim 35 wherein Receipt further comprises retrieval information for one of said First Transactor's or Second Transactor's public keys.

37. The method of claim 32 wherein said Author has a key pair consisting of a private key and a public key, and said Author Verification Information comprises information encrypted by said Author's private key.

38. The method of claim 32 further comprising the steps of:
(g) associating Author Verification Information with said Auditable Document;
(h) combining said Author Verification Information and indicia of said Auditable Document into a Verifiable Audit Record.

39. A method for generating a Verifiable Audit Record comprising the steps of:
(a) an Author submitting an Auditable Document to a Notary;
(b) said Notary storing said Auditable Document, an identity of said Author and Author Verification Information;
(c) said Notary generating a Message Digest, wherein said Message Digest comprises the output of a one-way hash function, wherein the input to said one-way hash function comprises said Auditable Document, said identity of said Author, and said Author Verification Information;
(d) said Notary placing said Message Digest so as to be observable by an Auditor.

40. A method for verifying that a Notary has not changed a Message Digest available to an Auditor, comprising the steps of:
(a) said Auditor accessing said Message Digest;
(b) said Auditor storing said Message Digest;
(c) said Auditor determining that a subsequent accessed Message Digest is identical to said stored Message Digest.

41. A method for insuring data integrity comprising the steps of:
(a) providing by a Notary an Auditable Document, an identity of an Author, Author Verification Information and a Putative Message Digest
(b) generating by an Auditor a Test Message Digest, wherein said Test Message Digest comprises the output of a one-way hash function, wherein the input to said one-way hash function comprises said Auditable Document, said identity of said Author, and said Author Verification Information;
(c) comparing by an Auditor said Putative Message Digest to said Test Message Digest.

42. A method for ensuring integrity of data comprising the steps of:
(a) providing a plurality of records, wherein said records comprise a plurality of Timestamps;
(b) verifying that said plurality of Timestamps are non-decreasing; and
(c) verifying that said plurality of Timestamps are all previous to the present time.

43. A method for collecting all documents from an Author comprising the step of:
(a) a Notary examining its Verifiable Audit Records for Author Verification Information; and
(b) storing said Verifiable Audit Record when said Author Verification Information indicates authorship by said Author.

44. The method of claim 43 further comprising the step of said Notary verifying the identity of said Author.

45. A method for verifying a Document comprising the steps of:
(a) providing a Notary's Public Record of said Document, wherein said Notary's Public Record comprises the output of a function, wherein the input to said function comprises information associated with said Document;
(b) generating a Test Record, wherein said Test Record comprises the output of a function, wherein the input to said function comprises information associated with said Document;
(c) verifying that said Notary's Public Record and said Test Record are identical.

46. The method of claim 39 comprising the additional step of said Notary providing a receipt wherein said receipt comprises a Notary's Digital Signature.

47. The method of claim 39 comprising the additional step of said Author verifying said Message Digest.

48. The method of claim 39 comprising the additional step of a second Notary notarizing said Notary's records.
